(19) United States
(12) Patent Application Publication
(10) Pub. No.: US 2022/0035942 A1
(43) Pub. Date: Feb. 3, 2022

(54) PRIVACY COMPLIANT AUDIT LOG

(71) Applicant: VMware, Inc., Palo Alto, CA (US)

(72) Inventors: Prateek JAIN, Cupertino, CA (US); Stephen SCHMIDT, Portola Valley, CA (US); Scott TILNEY, San Jose, CA (US); Pallavi VANAJA, Sunnyvale, CA (US); Gary GROSSI, San Jose, CA (US); Michelle LEE, Berkeley, CA (US)

(73) Assignee: VMware, Inc., Palo Alto, CA (US)

(21) Appl. No.: 17/153,126

(22) Filed: Jan. 20, 2021

Related U.S. Application Data
(60) Provisional application No. 63/059,025, filed on Jul. 30, 2020.

(51) Int. Cl. G06F 21/62; G06F 21/60

(52) U.S. Cl. CPC G06F 21/6245; G06F 2221/2113; G06F 2221/2141; G06F 21/604

(57) ABSTRACT

In a computer-implemented method for generating a privacy compliant audit log for a conversational interface, a request for information from a user is received at a conversational interface. A response to the request for information is generated, the response including data responsive to the request for information. It is determined whether the response comprises private user data. An audit log including the request and information related to the response is generated, where the information related to the response does not include the private user data.

### RELATED APPLICATIONS

This application claims priority to and the benefit of co-pending U.S. Patent Provisional Patent Application 63/059,025, filed on Jul. 30, 2020, entitled “CONVERSATIONAL INTERFACE ENHANCEMENTS,” by Jain et al., having Attorney Docket No. G800.PRO, and assigned to the assignee of the present application, which is incorporated herein by reference in its entirety.

### BACKGROUND

Conversational interfaces, often referred to as virtual assistants, are types of user interfaces for computers that emulate human conversation for translating human speech commands into computer-actionable commands. Examples of virtual assistants include Apple's Siri and Amazon's Alexa. A bot is an example of a software application that can utilize a conversational interface for performing designed operations.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 is a block diagram illustrating an example system for generating a privacy compliant audit log of a conversational interface, in accordance with embodiments.

FIG. 2 is a block diagram illustrating an example privacy compliant audit log, in accordance with embodiments.

FIG. 3A illustrates an example user input and response of a conversational interface, according to an embodiment.

FIG. 3B illustrates an example privacy compliant audit log based on the example user input and response of FIG. 3A, according to an embodiment.

FIG. 4 illustrates a screen shot of an example user interface for onboarding a new response, according to various embodiments.

FIG. 5 illustrates a screen shot of an example user interface for controlling privacy settings for domains, according to various embodiments.

FIG. 6 is a block diagram illustrating an example computer system upon which embodiments of the present invention can be implemented.

FIG. 7 is a flow diagram illustrating an example method for generating a privacy compliant audit log of a conversational interface, in accordance with embodiments.

FIG. 8 is a flow diagram illustrating an example method for determining whether the response includes private user data, in accordance with an embodiment.

FIG. 9 is a flow diagram illustrating an example method for determining whether the response includes private user data, in accordance with another embodiment.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### NOTATION AND NOMENCLATURE

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “determining,” “identifying,” “comparing,” “generating,” “executing,” “retrieving,” “storing,” or the like, refer to the actions and processes of an electronic computing device or system such as: a host processor, a processor, a memory, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions or code residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may include random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, code and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example system for generating a privacy compliant audit log of a conversational interface, according to various embodiments. An example computer system environment, upon which embodiments of the present invention may be implemented, is then described. Example operations of a system for generating a privacy compliant audit log of a conversational interface are then described.

Example embodiments described herein provide systems and methods for generating a privacy compliant audit log for a conversational interface. In accordance with the described embodiments, a request for information from a user is received at a conversational interface. A response to the request for information is generated, the response including data responsive to the request for information. It is determined whether the response comprises private user data. An audit log including the request and information related to the response is generated, where the information related to the response does not include the private user data.

Conversational or natural language interfaces convert spoken words into computer-understandable information and/or commands. Various applications or bots can utilize a conversational interface for performing different operations. Conversational interfaces are used in both consumer environments (e.g., Apple's Siri and Amazon's Alexa) or enterprise environments. For example, a bot may allow a user to retrieve information from their private appointment calendar or may allow for the viewing of a local cafe menu of the enterprise through a conversational interface.

Audit logs are essential for training and improving conversational interfaces. Audit logs are used by developers and administrators to identify issues or trends on how users are using applications through a conversational database. As such, audit logs are most useful when they include information that fully represents any interaction with a conversational interface. However, at the enterprise level, privacy and security compliance is paramount as a result of enhanced security concerns. For instance, enterprises may have internal policies on storage and access of private user data. Moreover, governments around the world have been enacting laws that require the ability to identify private user data and remove it upon request, or to not obtain the private user data by not capturing it in the first place.

Embodiments described herein provide privacy compliant audit logs at the enterprise level. The described embodiments allows conversational interface developers and administrators to see conversations as they would have happened between a bot and user while withholding any sensitive or personally identifiable information. In some embodiments, the developers or administrators can determine privacy settings and redact or strip out that information from the audit logs. For example, privacy settings may be set to redact all personally identifiable information (e.g., names, addresses, social security numbers, etc.) from the audit log, ensuring privacy compliance, while still providing an audit log with information that can be used for training the bot or analyzing bot performance.

In accordance with the described embodiments, a request for information from a user is received at a conversational interface. In some embodiments, a user intent of the request for information is identified. The data responsive to the request for information is retrieved based at least in part on the user intent of the request for information. In some embodiments, the data responsive to the request for information is retrieved from a system including public data and private user data. In some embodiments, the system including public data and private user data is an enterprise system.

A response to the request for information is generated, the response including data responsive to the request for information. It is determined whether the response comprises private user data. In some embodiments, determining whether the response comprises private user data includes determining whether the data responsive to the request for information is associated with a private domain. Provided the data responsive to the request for information is associated with a private domain, it is determined the data responsive to the request includes private user data. In some embodiments, the information related to the response includes a data type of the private domain. In some embodiments, determining whether the response comprises private user data includes determining a response type of the response. Provided the response type is indicated as private, it is determined that the data responsive to the request comprises private user data.

An audit log including the request and information related to the response is generated, where the information related to the response does not include the private user data. In some embodiments, the audit log further includes the request. In some embodiments, the information related to the response includes a data type of the private user data.

### Example System for Generating a Privacy Compliant Audit Log of a Conversational Interface

Example embodiments described herein provide systems and methods for generating a privacy compliant audit log for a conversational interface for allowing a developer or administrator to access logs of a conversational interface without disclosing any private user data. In accordance with the described embodiments, a request for information from a user is received at a conversational interface. A response to the request for information is generated, the response including data responsive to the request for information. It is determined whether the response comprises private user data. An audit log including the request and information related to the response is generated, where the information related to the response does not include the private user data.

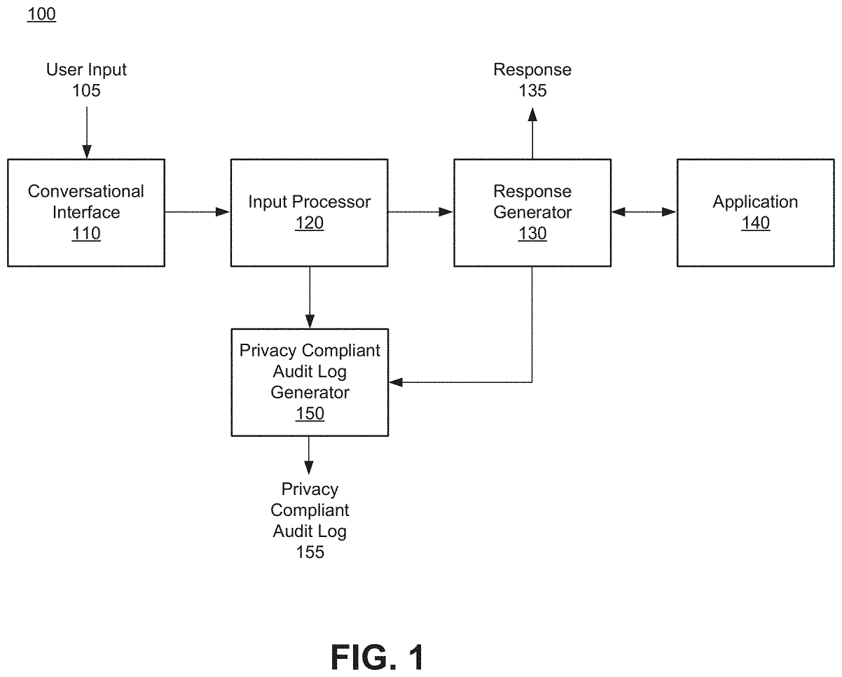

FIG. 1 is a block diagram illustrating an example system 100 for generating a privacy compliant audit log of a conversational interface, in accordance with embodiments. In accordance with various embodiments, system 100 includes conversational interface 110, input processor 120, response generator 130, application 140, and privacy compliant audit generator 150. It should be appreciated that conversational interface 110, input processor 120, response generator 130, application 140, and privacy compliant audit generator 150 can be under the control of a single component of an enterprise computing environment (e.g., a virtualization infrastructure or computer system 600) or can be distributed over multiple components (e.g., a virtualization infrastructure or a cloud-based infrastructure). In some embodiments, system 100 is comprised within or is an enterprise system.

User input 105 is received at conversational interface 110 of system 100, where user input 105 is a spoken utterance of a user. User input 105 is generally a request for information or execution of an action using application 140. For example, user input 105 can be a request for information about daily appointments of the user (e.g., “what is on my calendar for tomorrow?) or a request to send an email to a contact (e.g., “send John Smith an email asking when the report is going to be completed?”)

A conversational (or natural language) interface application, sometimes referred to as a “virtual assistant,” converts spoken words into computer-understandable information and/or commands. At input processor 120, user input 105 is processed such that user input 105 is converted into computer-understandable information and/or commands. In some embodiments, input processor 120 is configured to identify a user intent of user input 105. Input processor 120 forwards text of user input 105 to privacy compliant audit log generator 150 and forwards computer-understandable information and/or commands of user input 105 to response generator 130.

Response generator 130 generates a response to user input 105 by retrieving data responsive to user input 105. For example, where user input 105 is a request for information, response generator 130 retrieves data responsive to the request for information. In some embodiments, response generator 130 determines an application 140 of system 100 that is capable of accessing information or executing actions responsive to user input 105. It should be appreciated that system 100 can include any number or type of applications 140 that can be responsive to user input 105 received at conversational interface 110. Moreover, It should be appreciated that an application 140 can in turn communicate with any type of internal or remote data repository for retrieving information responsive to user input 105. For example, and without limitation, application 140 can include or be capable of retrieving user contact lists, user personal calendars, people search results, corporate calendars, frequently answered questions, technical support, etc. In some embodiments, the data responsive to the request for information is retrieved from a system including public data and private user data. In some embodiments, the system including public data and private user data is an enterprise system.

In some embodiments, response generator 130 determines a domain or data type of the domain from which the data was retrieved. The domain indicates the source of the retrieved data, where some domains include public information and some domains include private information. In some embodiments, response generator 130 determines a response type of the response, wherein some response types are indicated as publicly accessible and some response types are indicated as including private data.

Response generator 130 communicates with application 140 to retrieve information responsive to user input 105 and generates response 135. Response 135 is then communicated such that the user that caused the creation of user input 105 receives response 135. For example, response 135 can be communicated to a device (e.g., smart phone or computer) that received user input 105. In one embodiment, response generator 130 is configured to output response 135 (e.g., as a textual response). In another embodiment, conversational interface 110 is configured to output response 135 (e.g., as an audible response).

Response generator 130 also forwards response 135 to privacy compliant audit log generator 150. Privacy compliant audit log generator 150 is configured to generate a privacy compliant audit log 155 that includes information related to response 135, wherein the information related to response 135 does not include private data (e.g., private user data).

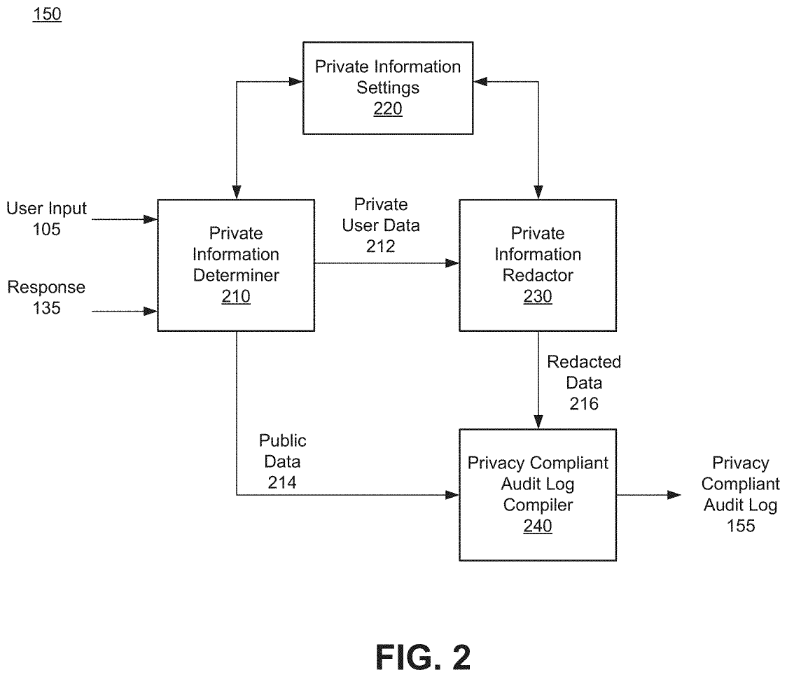

FIG. 2 is a block diagram illustrating an example privacy compliant audit log generator 150, in accordance with embodiments. Privacy compliant audit log generator 150 is configured to generate a privacy compliant audit log 155 that includes information related to response 135, wherein the information related to response 135 does not include private data. In accordance with various embodiments, privacy compliant audit log generator 150 includes private information determiner 210, private information settings 220, private information redactor 230, and privacy compliant audit log compiler 240.

Response 135 is received at private information determiner 210. Private information determiner 210 is configured to analyze response 135 and determine if response 135 includes private information, such as private user data. In some embodiments, private information determiner 210 accesses private information settings 220 to determine whether response 135 includes private information. For example, private information settings 220 may include information about the domain from which response 135 is generated (e.g., whether the domain includes public data or private data). Private information settings 220 may include information about the response type of response 135, where some response types are indicated as including publicly accessible information and some response types are indicated as including private data.

Private information determiner 210 forwards responses 135 including private user data to private information redactor 230 and forwards responses 135 including only public data 214 to privacy compliant audit log compiler 240. Private information redactor 230 accesses private information settings 220 to determine how to redact the contact information from a personal contact list for inclusion in privacy compliant audit log 155. Private information redactor 230 generates redacted data 216 based on private user data 212 by removing or replacing private user data 212 with information related to response 135 that does not include private information as indicated in private information settings 220. For example, redacted data 216 may describe a response type or a domain type of response 135 while obfuscating or otherwise redacting private user data 212.

For example, response 135 includes contact information from a personal contact list. Private information determiner 210 determines whether contact information from a personal contact list by accessing private information settings 220. In this example, private information settings 220 indicates that a contact information from a personal contact list is private user data. Private information determiner 210 then forwards response 135 including the contact information from a personal contact list to private information redactor 230. Private information redactor 230 accesses private information settings 220 to determine how to redact the contact information from a personal contact list for inclusion in privacy compliant audit log 155. For example, private information settings 220 may indicate that contact information from a personal contact list be replaced with a statement that indicates that personal contact information was retrieved without including the actual contact information. The statement indicating that personal contact information was retrieved is forwarded to privacy compliant audit log compiler 240 for inclusion in privacy compliant audit log 155.

It should be appreciated that in some embodiments, user input 105 is also received at private information determiner 210, where user input 105 is also analyzed to determine whether it includes private information to be redacted. User input 105 is analyzed in a similar manner as response 135. In some embodiments, private information determiner 210 accesses private information settings 220 to determine whether user input 105 includes private information. For example, private information settings 220 may include information indicating that user input 105 including personal information (e.g., “please confirm my appointment with John Smith tomorrow at 10:30 am), wherein user input 105 including names or times/dates is indicated as private data.

Private information determiner 210 forwards user input 105 including private user data 212 to private information redactor 230 and forwards user input 105 including only public data 214 to privacy compliant audit log compiler 240. Private information redactor 230 accesses private information settings 220 to determine how to redact the information from user input 105 for inclusion in privacy compliant audit log 155. Private information redactor 230 generates redacted data 216 based on private user data 212 by removing or replacing private user data 212 with information related to user input 105 that does not include private information as indicated in private information settings 220. For example, redacted data 216 may describe a request type of user input 105 while obfuscating or otherwise redacting private user data 212.

Privacy compliant audit log compiler 240 compiles public data 214 and redacted data 216 into privacy compliant audit log 155. Privacy compliant audit log 155 includes information related to response 135 and/or user input 105 without including any private data.

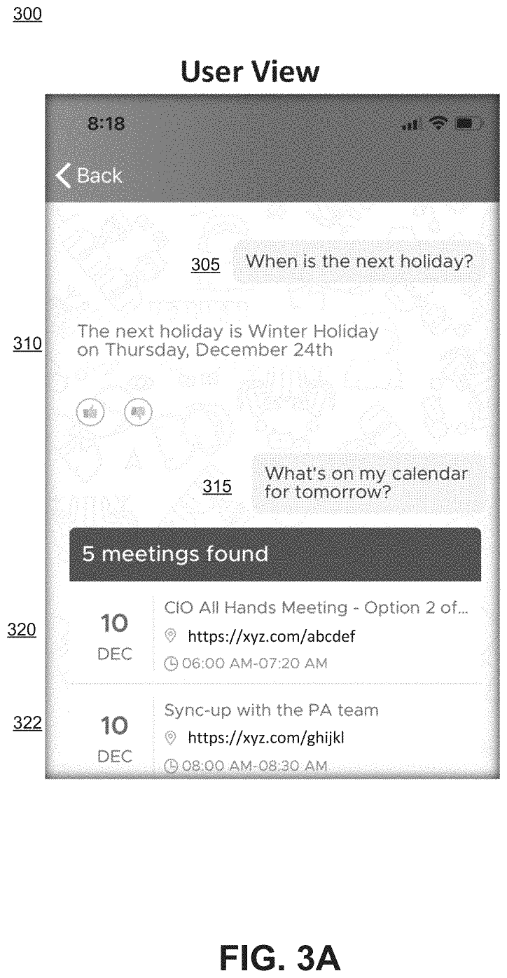

FIG. 3A illustrates a user view 300 an example user input and response of a conversational interface (e.g., conversational interface 110 of FIG. 1), according to an embodiment. User view 300 illustrates user input 305 that recites “When is the next holiday?” It should be appreciated that user input 305 is a spoken request, and that user view 300 illustrates the transcribed user input 305 (e.g., as determined by input processor 120 of FIG. 1). Response 310 provides the response to user input 105, reciting “The next holiday is Winter Holiday on Thursday, December 24^{th}.” User view 300 also illustrates user input 315 that recites “What's on my calendar for tomorrow” and responses 320 and 322 of two appointments that satisfy the request.

FIG. 3B illustrates an example privacy compliant audit log view 350 based on the example user input and response of FIG. 3A, according to an embodiment. Audit log view 350 illustrates user input 305 from FIG. 3A, and response 310 to user input 305, as response 310 is determined to include public data (e.g., company or national holidays).

Audit log view 350 also includes user input 315 from FIG. 3A. However, as the responses to user input 315 include private user data (e.g., personal calendar information), response 355 of audit log view 350 is a redacted version of responses 320 and 322 of FIG. 3A. As illustrated, response 355 indicates that the response to user input 315 is “[Private]” and includes information related to responses 320 and 322 in indicating that the response to user input 315 was related to retrieving meeting information by data (e.g., “get_meetings_by_date”).

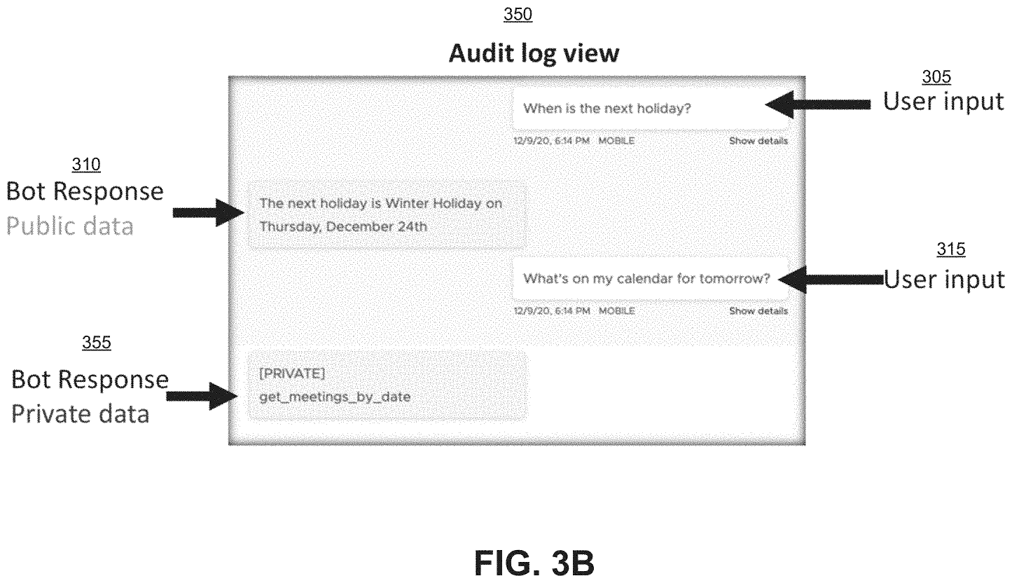

FIG. 4 illustrates a screen shot of an example user interface 400 for onboarding a new response of a conversational interface, according to various embodiments. Responses are added to a conversational interface for purposes of providing a response to particular requests for information. The response of FIG. 4 is for providing a next meeting to a user in response to a request for their next meeting. User interface 400 includes a text field for receiving a Response ID 410 (“get_next_meeting”). Drop down menu 420 allows for the selection of a domain used for accessing the response to the request. As illustrated, the domain is “Personal Calendar.” Message 430 includes a text field for presenting the requested information to a user. As illustrated, message 430 recites “Your next meeting is on {date}.” A user requesting “when is my next meeting” would be handled according to the input of user interface 400. In response to receiving such a request, the Personal Calendar domain is accessed, and the “{date}” information of the response message is completed with information retrieved from the Personal Calendar domain.

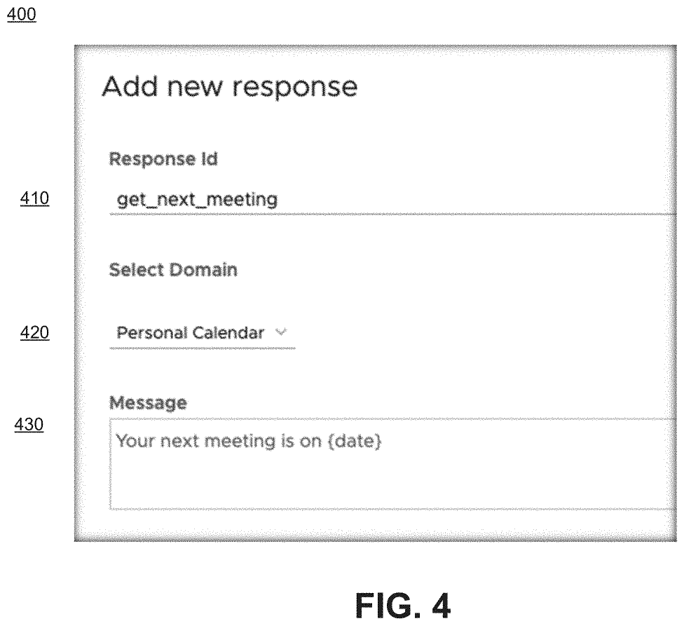

FIG. 5 illustrates a screen shot of an example user interface 500 for controlling privacy settings for domains, according to various embodiments. User interface 500 illustrates a number of domains accessible by a conversational interface, including personal calendar domain 510 and corporate calendar domain 520. Each domain includes information describing the domain, including name 502 and privacy setting 504. Privacy setting 504 is selectable for turning on or off, where on indicates that the domain is private (e.g., includes private data) and off indicating that the domain is not private (e.g., does not include private data).

As illustrated, personal calendar domain 510 is indicated as private at privacy setting 530 and corporate calendar domain 520 is indicated as not private at privacy setting 540. For example, as illustrated in FIG. 4, the domain accessed corresponding to Response ID 410 is the Personal Calendar domain. Therefore, using the privacy setting 540, the response to a request for providing a next meeting includes private information. Accordingly, the response is redacted from the privacy compliant audit log. For example, the response in the privacy compliant audit log could indicate that the response is “[Private]” and can include the Response ID 410, an indication of the domain accessed, or message 430 without the retrieved information.

The described embodiments allow for generation of a privacy compliant audit log for a conversational interface. Accordingly, the described embodiments improve performance of conversational interfaces by allowing developers and administrators access to necessary audit logs without accessing private user data. Moreover, embodiments of the present invention amount to significantly more than merely using a computer to perform the privacy compliant audit log generation. Instead, embodiments of the present invention specifically recite a novel process, rooted in computer technology, for privacy compliant audit log generation, to overcome a problem specifically arising in the realm of conversational interfaces.

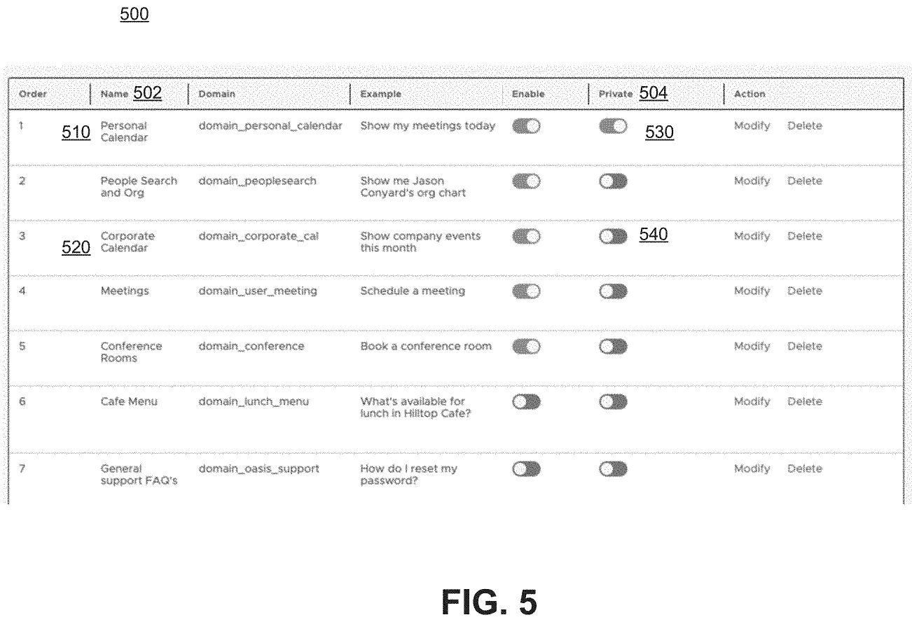

FIG. 6 is a block diagram of an example computer system 600 upon which embodiments of the present invention can be implemented. FIG. 6 illustrates one example of a type of computer system 600 (e.g., a computer system) that can be used in accordance with or to implement various embodiments which are discussed herein.

It is appreciated that computer system 600 of FIG. 6 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 600 of FIG. 6 is well adapted to having peripheral tangible computer-readable storage media 602 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 600 of FIG. 6 includes an address/data bus 604 for communicating information, and a processor 606A coupled with bus 604 for processing information and instructions. As depicted in FIG. 6, computer system 600 is also well suited to a multi-processor environment in which a plurality of processors 606A, 606B, and 606C are present. Conversely, computer system 600 is also well suited to having a single processor such as, for example, processor 606A. Processors 606A, 606B, and 606C may be any of various types of microprocessors. Computer system 600 also includes data storage features such as a computer usable volatile memory 608, e.g., random access memory (RAM), coupled with bus 604 for storing information and instructions for processors 606A, 606B, and 606C. Computer system 600 also includes computer usable non-volatile memory 610, e.g., read only memory (ROM), coupled with bus 604 for storing static information and instructions for processors 606A, 606B, and 606C. Also present in computer system 600 is a data storage unit 612 (e.g., a magnetic or optical disc and disc drive) coupled with bus 604 for storing information and instructions. Computer system 600 also includes an alphanumeric input device 614 including alphanumeric and function keys coupled with bus 604 for communicating information and command selections to processor 606A or processors 606A, 606B, and 606C. Computer system 600 also includes a cursor control device 616 coupled with bus 604 for communicating user input information and command selections to processor 606A or processors 606A, 606B, and 606C. In one embodiment, computer system 600 also includes a display device 618 coupled with bus 604 for displaying information.

Referring still to FIG. 6, display device 618 of FIG. 6 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 616 allows the computer user to dynamically signal the movement of a visible symbol (cursor) on a display screen of display device 618 and indicate user selections of selectable items displayed on display device 618. Many implementations of cursor control device 616 are known in the art including a trackball, mouse, touch pad, touch screen, joystick or special keys on alphanumeric input device 614 capable of signaling movement of a given direction or manner of displacement. Alternatively, it will be appreciated that a cursor can be directed and/or activated via input from alphanumeric input device 614 using special keys and key sequence commands. Computer system 600 is also well suited to having a cursor directed by other means such as, for example, voice commands. In various embodiments, alphanumeric input device 614, cursor control device 616, and display device 618, or any combination thereof (e.g., user interface selection devices), may collectively operate to provide a graphical user interface (GUI) 630 under the direction of a processor (e.g., processor 606A or processors 606A, 606B, and 606C). GUI 630 allows user to interact with computer system 600 through graphical representations presented on display device 618 by interacting with alphanumeric input device 614 and/or cursor control device 616.

Computer system 600 also includes an I/O device 620 for coupling computer system 600 with external entities. For example, in one embodiment, I/O device 620 is a modem for enabling wired or wireless communications between computer system 600 and an external network such as, but not limited to, the Internet. In one embodiment, I/O device 620 includes a transmitter. Computer system 600 may communicate with a network by transmitting data via I/O device 620. In accordance with various embodiments, I/O device 620 includes a microphone for receiving human voice or speech input (e.g., for use in a conversational or natural language interface).

Referring still to FIG. 6, various other components are depicted for computer system 600. Specifically, when present, an operating system 622, applications 624, modules 626, and data 628 are shown as typically residing in one or some combination of computer usable volatile memory 608 (e.g., RAM), computer usable non-volatile memory 610 (e.g., ROM), and data storage unit 612. In some embodiments, all or portions of various embodiments described herein are stored, for example, as an application 624 and/or module 626 in memory locations within RAM 608, computer-readable storage media within data storage unit 612, peripheral computer-readable storage media 602, and/or other tangible computer-readable storage media.

### Example Methods of Operation

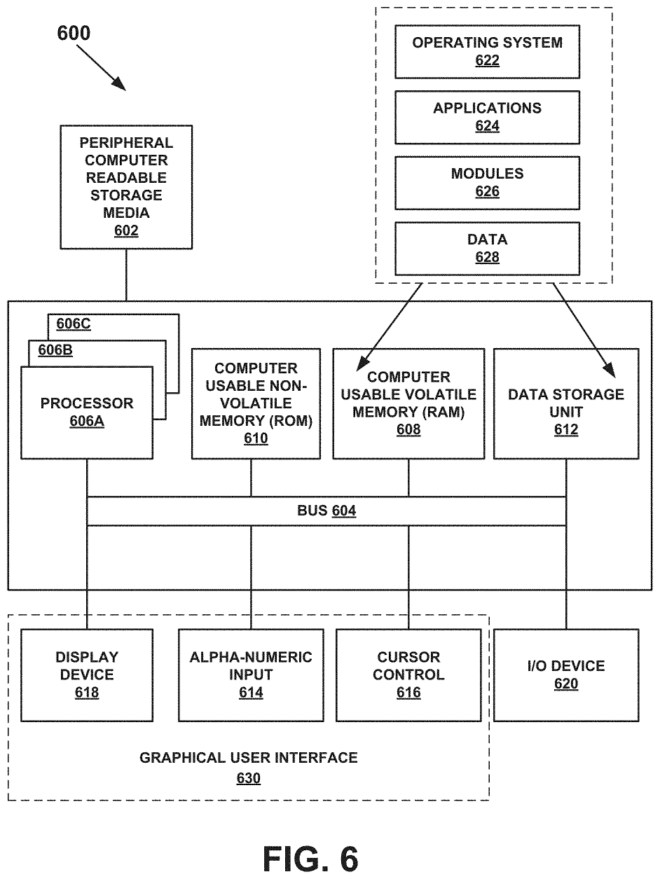

The following discussion sets forth in detail the operation of some example methods of operation of embodiments. With reference to FIGS. 7 through 9, flow diagrams 700, 800, and 900 illustrate example procedures used by various embodiments. The flow diagrams include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 600). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in the flow diagrams may be performed in an order different than presented and/or not all of the procedures described in the flow diagrams may be performed. It is further appreciated that procedures described in the flow diagrams may be implemented in hardware, or a combination of hardware with firmware and/or software provided by computer system 600.

FIG. 7 is a flow diagram 700 illustrating an example method for generating a privacy compliant audit log of a conversational interface, in accordance with embodiments. At procedure 710 of flow diagram 700, a request for information from a user is received at a conversational interface. In some embodiments, as shown at procedure 712, a user intent of the request for information is identified. In some embodiments, as shown at procedure 714, the data responsive to the request for information is retrieved based at least in part on the user intent of the request for information. In some embodiments, the data responsive to the request for information is retrieved from a system including public data and private user data. In some embodiments, the system including public data and private user data is an enterprise system.

At procedure 720, a response to the request for information is generated, the response including data responsive to the request for information. As shown at procedure 730, it is determined whether the response comprises private user data.

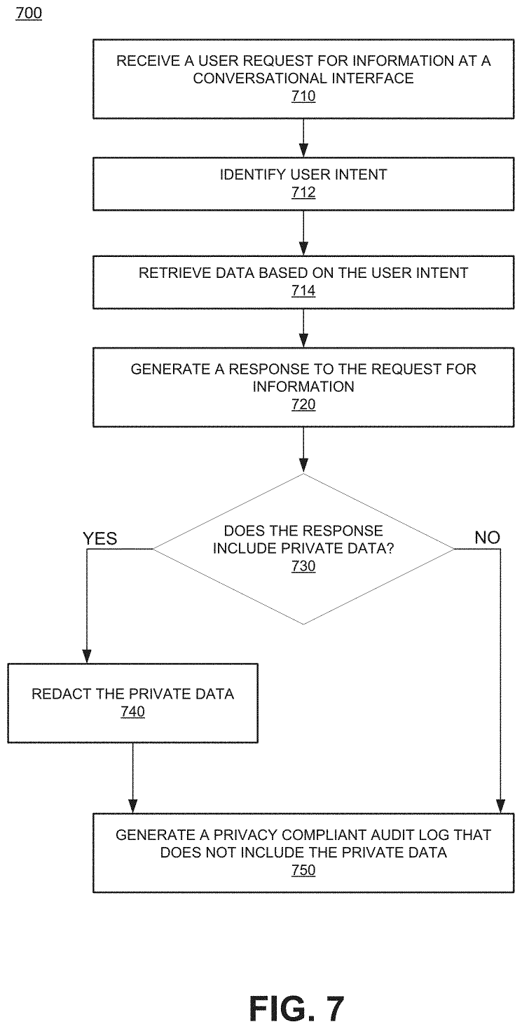

In one embodiment, procedure 730 is performed according to flow diagram 800 of FIG. 8. FIG. 8 is a flow diagram 800 illustrating an example method for determining whether the response includes private user data, in accordance with an embodiment.

As shown at procedure 810 of flow diagram 800, determining whether the response comprises private user data includes determining whether the data responsive to the request for information is associated with a private domain. Provided the data responsive to the request for information is associated with a private domain, as shown at procedure 820, it is determined the data responsive to the request includes private user data. In some embodiments, the information related to the response includes a data type of the private domain. Provided the data responsive to the request for information is not associated with a private domain, as shown at procedure 830, it is determined the data responsive to the request does not include private user data.

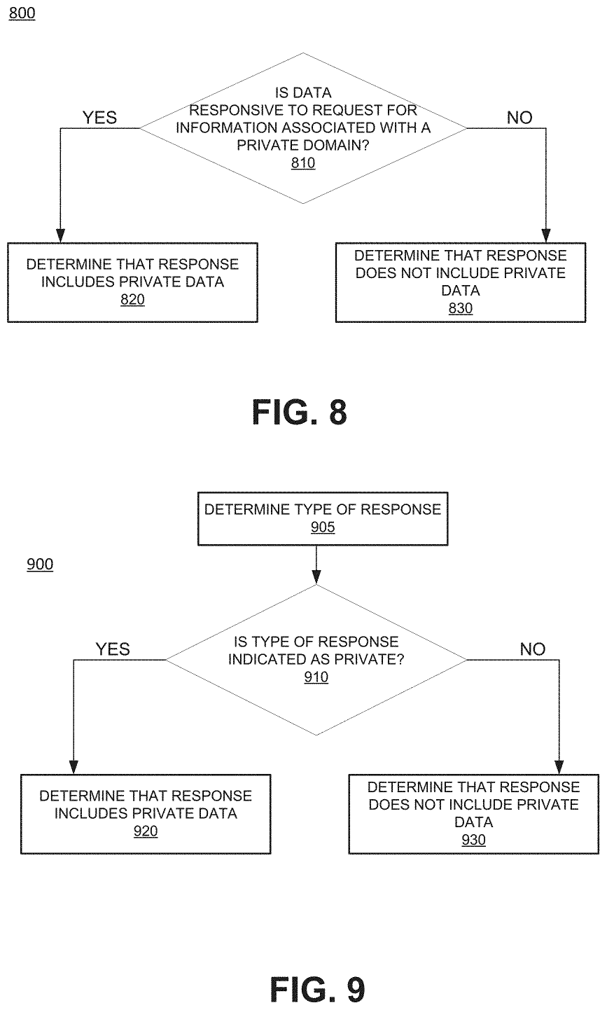

In another embodiment, procedure 730 is performed according to flow diagram 900 of FIG. 9. FIG. 9 is a flow diagram 900 illustrating an example method for determining whether the response includes private user data, in accordance with another embodiment. In some embodiments, determining whether the response comprises private user data includes determining a response type of the response.

As shown at procedure 905 of flow diagram 900, a type of response is determined. At procedure 910, it is determined whether the type of response is indicated as private. Provided the response type is indicated as private, as shown at procedure 920, it is determined that the data responsive to the request includes private user data. Provided the response type is not indicated as private, as shown at procedure 930, it is determined that the data responsive to the request does not include private user data.

With reference to FIG. 7, as shown at procedure 740, if the response includes private data, the private data is redacted. In some embodiments, redacting the private data includes replacing the private data with a type of data of the response.

At procedure 750, an audit log including the request and information related to the response is generated, where the information related to the response does not include the private user data. In some embodiments, the audit log further includes the request. In some embodiments, the information related to the response includes a data type of the private user data.

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A computer-implemented method for generating a privacy compliant audit log for a conversational interface, the method comprising:
receiving a request for information from a user at a conversational interface;
generating a response to the request for information, the response comprising data responsive to the request for information;
determining whether the response comprises private user data; and
generating an audit log comprising information related to the response, wherein the information related to the response does not comprise the private user data.

2. The method of claim 1, wherein the determining whether the response comprises private user data comprises:
determining whether the data responsive to the request for information is associated with a private domain; and
provided the data responsive to the request for information is associated with a private domain, determining that the data responsive to the request comprises private user data.

3. The method of claim 2, wherein the information related to the response comprises a data type of the private domain.

4. The method of claim 1, wherein the determining whether the response comprises private user data comprises:
determining a response type of the response; and
provided the response type is indicated as private, determining that the data responsive to the request comprises private user data.

5. The method of claim 1, the method further comprising:
identifying user intent of the request for information; and
retrieving the data responsive to the request for information based at least in part on the user intent of the request for information.

6. The method of claim 1, wherein the data responsive to the request for information is retrieved from a system comprising public data and private user data.

7. The method of claim 6, wherein the system comprising public data and private user data is an enterprise system.

8. The method of claim 1, wherein the information related to the response comprises a data type of the private user data.

9. The method of claim 1, wherein the audit log further comprises the request.

10. A non-transitory computer readable storage medium having computer readable program code stored thereon for causing a computer system to perform a method for generating a privacy compliant audit log for a conversational interface, the method comprising:
receiving a request for information from a user at a conversational interface;
generating a response to the request for information, the response comprising data responsive to the request for information;
determining whether the response comprises private user data; and
generating an audit log comprising the request and information related to the response, wherein the information related to the response does not comprise the private user data.

11. The non-transitory computer readable storage medium of claim 10, wherein the determining whether the response comprises private user data comprises:
determining whether the data responsive to the request for information is associated with a private domain; and
provided the data responsive to the request for information is associated with a private domain, determining that the data responsive to the request comprises private user data.

12. The non-transitory computer readable storage medium of claim 11, wherein the information related to the response comprises a data type of the private domain.

13. The non-transitory computer readable storage medium of claim 10, wherein the determining whether the response comprises private user data comprises:
determining a response type of the response; and
provided the response type is indicated as private, determining that the data responsive to the request comprises private user data.

14. The non-transitory computer readable storage medium of claim 10, the method further comprising:
identifying user intent of the request for information; and
retrieving the data responsive to the request for information based at least in part on the user intent of the request for information.

15. The non-transitory computer readable storage medium of claim 10, wherein the data responsive to the request for information is retrieved from a system comprising public data and private user data.

16. The non-transitory computer readable storage medium of claim 15, wherein the system comprising public data and private user data is an enterprise system.

17. The non-transitory computer readable storage medium of claim 10, wherein the information related to the response comprises a data type of the private user data.

18. A computer system comprising:
a data storage unit; and
a processor coupled with the data storage unit, the processor configured to:
receive a request for information from a user at a conversational interface;
generate a response to the request for information, the response comprising data responsive to the request for information;
determine whether the response comprises private user data; and
generate an audit log comprising the request and information related to the response, wherein the information related to the response does not comprise the private user data.

19. The computer system of claim 18, wherein the processor is further configured to:
determine whether the data responsive to the request for information is associated with a private domain; and
provided the data responsive to the request for information is associated with a private domain, determine that the data responsive to the request comprises private user data.

20. The computer system of claim 19, wherein the information related to the response comprises a data type of the private domain.
